(19) United States
(12) Patent Application Publication
(10) Pub. No.: US 2013/0279188 A1
(43) Pub. Date: Oct. 24, 2013

(54) INTERIOR COMPONENT AND METHOD FOR PRODUCING SAME

(71) Applicants: Volker Entenmann, Affalterbach (DE); Stefan Herder, Pressath (DE); Joerg Reisinger, Loechgau (DE)

(72) Inventors: Volker Entenmann, Affalterbach (DE); Stefan Herder, Pressath (DE); Joerg Reisinger, Loechgau (DE)

(73) Assignee: Daimler AG, Stuttgart (DE)

(21) Appl. No.: 13/991,438

(22) PCT Filed: Nov. 22, 2011
(86) PCT No.: PCT/EP11/05874

§ 371 Date: Jun. 4, 2013

(30) Foreign Application Priority Data
Dec. 6, 2010 (DE) 10 2010 053 578.8

(51) Int. Cl. B60Q 3/00

(52) U.S. Cl. CPC B60Q 3/00
USPC 362/488; 430/320

(57) ABSTRACT

A motor vehicle interior component with a multilayer design, with at least one inhomogeneously structured decorative layer (1), which has a plurality of regions (11, 12) of different transparencies. The decorative layer (1) is a side of the interior component that is facing an observer and includes at least one region (2) for the display of an image. A light source (4) is provided on the side of the decorative layer (1) facing away from the observer. The decorative layer (1) has a masking layer (3) on the side of the light source, with masking sections (31, 32) of different transparencies. Masking sections of lower transparency (31) are arranged on regions of higher transparency (11) and masking sections of higher transparency (32) and arranged on regions of lower transparency (12) of the decorative layer (1). A method for the production of such an interior component is disclosed.

The invention relates to an interior component and a method for producing the interior component.

It is known, in motor vehicles, to apply backlit operating elements; for example in the central console, the inside door panelling or the dashboard, so that these can be seen and operated even in darkness. Also, for purposes of visual enhancement, interior components in motor vehicles are increasingly equipped with ambient lighting.

Thus, a wooden trim part for a motor vehicle interior is known from DE 299 12 270 U1, which has a single or multilayer wooden structure on a carrier for the decoration of the interior of a higher-value personal automobile. The wooden trim part has, in an opening in the wooden structure and in the carrier, an insert, which is completely or partially backlit alone or with the wood trim. This insert consists of a stone and reflects onto incident light striking the insert. Thus, particularly worthwhile trim parts are created, which exude solidity and are still also suitable for use in production vehicles. Furthermore, reference is made to DE 197 44 379A 1 in DE 299 12 270 U1, in which a delivery means is disclosed for the positioning of a brand logo on an operating element of the vehicle, such as a door-locking button. The logo is designed to project and is backlit by any light source. A trim panelling for an interior of a motor vehicle is known from DE 195 24 602 A1, the front side of which in front of a lighting is transparent or transmissive.

DE 10 2007 054 348 A1 describes an interior component, which has a composite layer with a decorative layer and a transparent layer. The decorative layer comprises a plurality of openings, and a light source is provided on the side of the decorative layer that is facing away from the transparent layer. Here, a light-influencing material is present at least in some openings. Alternative or additionally, at least some openings only partially run through the decorative layer. Thus, the visible decorative surface is to appear virtually homogeneous when there is no backlighting, and when there is backlighting, it is to have improved and flexibly adaptable visual properties. Perforation of the decorative layer is thus carried out by a laser procedure.

Based on this prior art, the object arises to enable a homogeneous illumination, even for inhomogeneous structured decorative materials, in order to have the images applied to the backlit decorative components appear consistent.

This object is solved by an interior component having the features of claim 1.

A further object exists in the creation of a production method for such an interior component. The method with the features of claim 8 solves this object.

Developments of the subject matter and the method thereof are embodied in the respective sub-claims.

In a first embodiment of an interior component designed with multiple layers, an inhomogeneously structured decorative layer of the interior component has a plurality of regions with different transparencies. The decorative layer forms a side of the interior component that is facing towards an observer and comprises at least one region that shows an image. A light source is provided on the side of the decorative layer facing away from the observer, at least in the region of the image display.

According to the invention, the decorative layer has a masking layer on the light source side at least in the region of the image display, which consists of several masking sections or regions of different transparency. These masking sections are designed and arranged with respect to the regions of different transparency of the decorative layer in such a way that masking sections that have lower transparency adjoin regions of higher transparency of the decorative layer and masking sections with higher transparency adjoin regions with lower transparency of the decorative layer. The light-dark contrast for the illumination of the decorative layer is reduced by the adapted masking, such that particularly the lighting homogeneity is improved in the regions of image displays. The optical imaging of the inhomogeneous structure of the decorative layer by the backlighting can thus be diminished or even disabled at least in the regions in which a design element such as a symbol, text, character or, for example, a brand logo, is to be made visible by the backlighting.

Thus, the transparency of the various masking sections can be selected in such a way that the respective total transparency of a region of higher transparency of the decorative layer and of the masking section with lower transparency arranged thereon is the same as the total transparency of a region of lower transparency of the decorative layer and of the masking region with higher transparency arranged thereon. The transparency or, conversely, absorbance, is determined by the layer thickness and the absorbance coefficients of the masking section.

The masking layer can be embodied as an imprinted coating or varnish; it can, however, also be a film or paper layer. It is furthermore conceivable for the masking layer to be formed from a laminate layer, which consists of several of the aforementioned similar or different layers.

Alternatively, the masking layer can be formed by a photosensitive layer exposed from the observer side through the decorative layer, wherein the different transparencies of the masking sections are each formed by the exposure intensity, which pervades the regions of the decorative layer with different transparencies. In this case, the structure of the masking is visible.

In one embodiment of the interior component according to the invention, the image, the display region of which is located in the decorative layer, can be contained in the masking layer, i.e. the image is inserted into the masking layer in addition to the masking sections.

Furthermore, the interior component can comprise a carrier structure, on which the decorative layer is arranged. In addition, the arrangement of a transparent layer on the observer side of the decorative layer can be provided to protect the decorative layer, wherein this can preferably be a colourlessly transparent layer and, in particular, a clear varnish coat with corresponding chemical and mechanical resistance for the protection of the decorative layer from damage, for example from scratches or cleaning agents.

The decorative layer with the inhomogenous structure of the interior component can be, for example, a wooden decorative layer, wherein the regions of different transparencies are formed by the increased wood grain. Further suitable decorative layers can be formed from polymer mixtures, webs, laminates, and metal and organic materials such as leather or textiles. The surface area of the regions of different transparencies can here be variable in the course through the wooden decorative layer from the light source side to the observer side. Also, the regions of different transparencies arising from this can be masked by the method described below for the production of an interior component, even in sliding transitions.

Generally, to that end, the arrangement of the masking layer takes place at lest in the region of the image display on the light source side of the decorative layer, wherein the masking sections of lower transparency are arranged on the regions of higher transparency of the decorative layer and, conversely, the masking sections of higher transparency are arranged on the regions of lower transparency of the decorative layer.

In order to create the masking layer with the masking sections of different transparencies, which supplement the different transparencies of the decorative layer accordingly, the regions of different transparencies of the decorative layer are lit at least in the region of the image display before the arrangement of the masking layer, such that the lit regions of different transparencies of the decorative layer can be photographically imaged. With the aid of this photographic image, the masking layer with the masking sections is produced according to the photographically imaged, illuminated regions.

Alternatively to the photographic imaging step, the masking layer can also be created simply by applying a photosensitive layer at least onto the region of the image display on the light source side of the decorative layer, which hereupon is exposed through the decorative layer from the observer side. The exposed photosensitive layer can then form the masking sections of the masking layer exactly according to the transparency of the respective decorative layer regions, either directly or after treatment with a developer material, wherein strongly exposed sections form masking sections with lower transparency and vice versa, such that the compensation of the total transparency of the various regions of decorative layer and masking layer takes place simply, quickly and precisely with the exposure step, and thus a consistent and homogeneous overall transparency is created.

In order to obtain a consistent appearance of the illuminated masked decorative layer, if necessary, different exposure angles can be used or the exposure light source can be guided dynamically above the decorative layer. An exposure intensity that is Gaussian-distributed via the angle is, for example, possible.

The use of specialist light sources is also conceivable. Thus, an exposure light source, which generates coherent light, can be applied for lower scattering and/or for greater printing areas, for example.

In addition, the method according to the invention for the production of the interior component can comprise at least one of the following steps:
repeated application of layers for the formation of a multilayer masking layer,
generation of the image display in the masking layer,
arrangement of the masked decorative layer on a carrier structure of the interior component, and/or
formation of a transparent layer on the observer side of the decorative layer, wherein the transparent layer is preferably a colourless transparent layer, in particular a clear varnish coat.

In the repeated application of layers for the formation of a multilayer masking layer, the partially transparent masking layer can additionally effect a colour adjustment of the wood, such that symbols that are to be displayed do so in pure white, for example, without the typical woody shade. For example, wood is only very slightly transmissive for “blue”, such that the filter lacquer preferably has high blue and low red transmission. One possibility is the use of a classical colour film and illumination in the target colour.

These and other advantages are demonstrated by the description below with reference to the accompanying figures. The reference to the figures in the description serves to support the description and to facilitate understanding of the subject matter. The figures are only a schematic depiction of an embodiment of the invention.

The following can be seen in the figures:

FIG. 1 a top view onto a backlit display region in an inhomogeneously structured decorative layer,

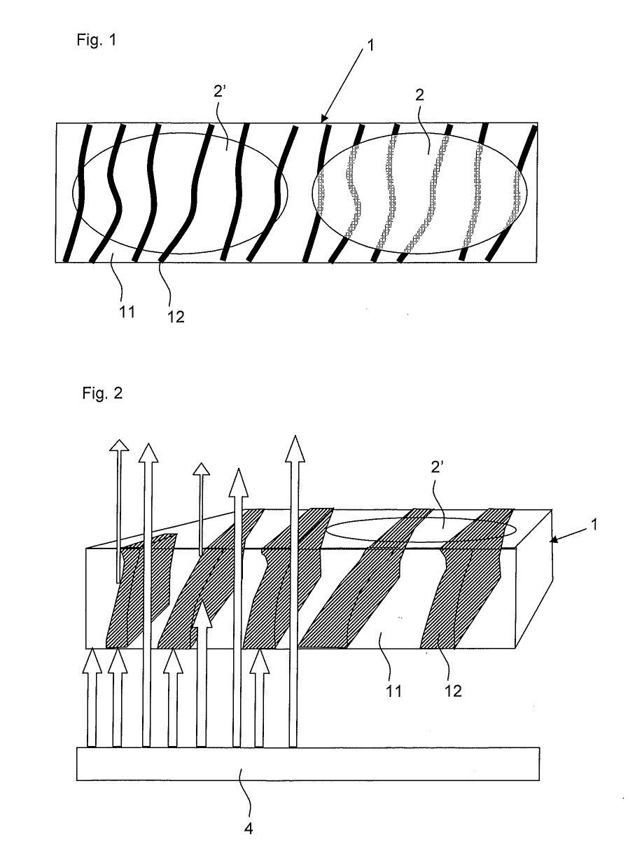

FIG. 2 a perspective view onto a section of the backlit decorative layer,

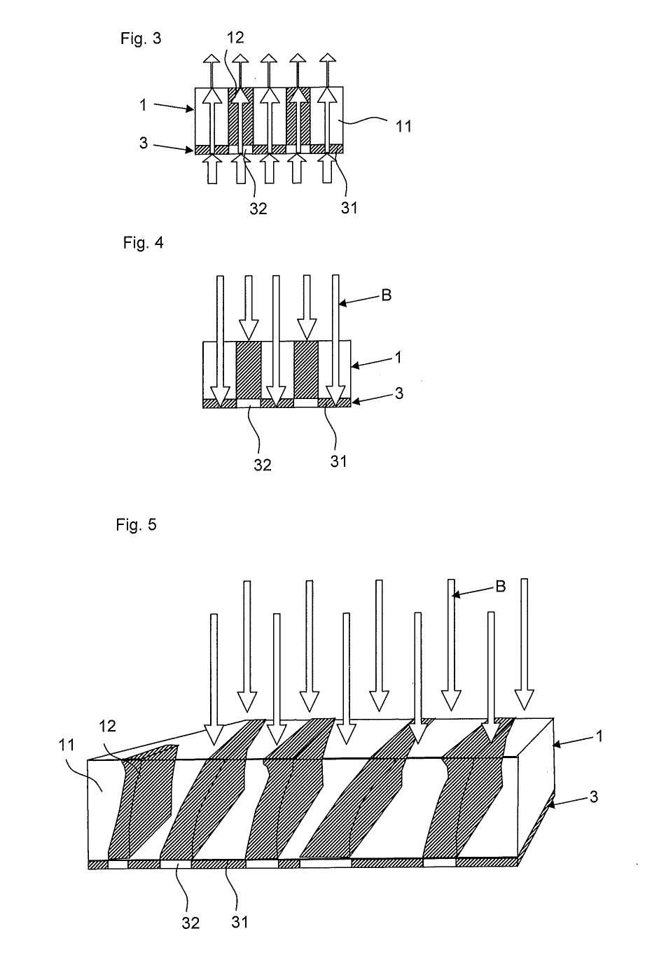

FIG. 3 a schematic detailled view through the backlit masked decorative layer,

FIG. 4 a schematic detailed view of a masking layer exposed on the observer side through the decorative layer,

FIG. 5 a perspective view onto a section of the masking layer exposed on the observer side through the decorative layer.

The edges and transitions between exposed and unexposed points are particularly critical. This can be optimised by the exposure in order to ensure that leaked light cannot be detected; this can also be prevented by repeated application and development of a masking layer.

During the lighting of inhomogeneous decorative materials such as wood, its structure is optically imaged. On the one hand, this can provide an attractive appearance, but on the other hand, however, can in part have a highly disadvantageous effect on the lighting homogeneity of displays. However, thinning from behind, which is carried out for the lighting of dark wood, for example by laser locking, does not allow any complete structural compensation in the increased inhomogeneous materials.

To that end, in FIG. 1, on the left-hand side, a display region 2′ is shown, which is backlit for the imaging of a design element, symbol or writing, in which, however, the grain of the wood of the decorative layer 1 is imaged disruptively with the regions of higher transparency 11 and lower transparency 12. On the right-hand side, the display region 2 of an interior component embodied according to the invention is to be seen, wherein the light-dark contrast between the regions 11, 12 of different transparencies of the decorative layer 1 is clearly reduced. This is implemented by means of the masking layer that is applied from behind (cf. FIGS. 3 to 5), which can be imprinted or applied by film, paper etc.

A spatially inhomogeneous structure of the decorative layer 1 is depicted in FIG. 2, in which the regions 11, 12 of different transparencies are drawn inconsistently through the thickness of the decorative layer 1. The light emitted by the light source 4, symbolised by the block arrows, is absorbed at different strengths during the passing of the decorative layer 1 into the regions 11, 12; stronger absorption or lower transmission is denoted by the thinner block arrows. Fluorescent lighting surfaces, lamps or other elements can be used as light sources 4, for example, which convert electrical energy into the desired light, so also LEDs, for example. It is, however, also conceivable to introduce light from a light source arranged at a distance via optical conductors. It is thus also possible for the layer to be applied on the optical conductor, to darken it accordingly or even to mechanically or geometrically structure it.

Since the transparency of the decorative layer 1 can vary along a light path depending on the course of the increased structure of the regions 11, 12, it is advantageous to adapt the masking sections of the masking layer dynamically to the structure.

As is illustrated in FIG. 3, the light regions, i.e. regions of higher transparency 11 of the decorative layer 1, are shaded by the masking layer 3 through dark masking sections 31, i.e. with lower transparency, so as to thus reduce the contract between the light and dark regions 11, 12, of the decorative layer 1. The light masking sections 32, which are provided on the regions 12 with lower transparency of the decorative layer 1, have a correspondingly low transparency. If necessary, for example if the masking layer 3 is imprinted, these regions 32 can also be omitted. Due to the reduced total absorption, a higher luminosity of the light source 4 can be required, since, during the passage through the dark masked light regions 11 or the dark regions 12 of the decorative layer 1, a greater proportion of the light is absorbed, as is denoted by the thinning block arrows.

The at least partially masked decorative layer 1 according to the invention forms the observer side of a motor vehicle interior component having a multilayer structure. The inhomogeneous structured decorative layer 1, wherein this can be, for example, a wooden decorative layer, thus has regions 11, 12, of different transparencies. In addition, a region 2 or several regions 2 are provided in the decorative layer 1 to display an image, wherein a light source is provided on the side of the decorative layer 1 facing away from the observer, which illuminates at least the region 2 of the image display 4. The masking layer 3 applied on the light source side of the decorative layer 1 extends at least above the region 2 of the image display, so as to improve the illumination homogeneity there. If desired, the masking layer 3 can mask the entire decorative layer 1, in order to completely reduce the optical image of the inhomogeneous structure when there is backlighting. To that end, the masking layer consists of masking sections 31, 32 of different transparencies, which are applied to the decorative layer in such a way that the masking sections of lower transparency 31 adjoin the regions of higher transparency 11 of the decorative layer 1 and the masking sections of higher transparency 32 are in contact with regions of lower transparency 12 of the decorative layer 1.

The transparency of the respective masking sections 31, 32 can be selected in such a way that a total transparency of a region of higher transparency 11 of the decorative layer 1 and of the masking section 31 with lower transparency arranged thereon is the same as the total transparency of a region of lower transparency 12 of the decorative layer 1 and of the masking region 32 with higher transparency arranged thereon.

The masking layer 3 can consist simply of an imprinted coating or a varnish; it can, however, also be composed of a film layer or paper layer. A multilayer laminate masking layer, which can be included in combinations of the aforementioned layers, is also conceivable. A targeted 3D effect can also be achieved by such a multilayer masking layer.

In order to avoid the problem of a lack of positional exactitude during the imprinting or arrangement of the masking layer 3 on the decorative layer, the masking layer 3, as is depicted in FIGS. 4 and 5, can consist of a photosensitive layer that is exposed from the observer side by the decorative layer 1, wherein the different transparencies of the masking sections 31, 32 are each formed by an exposure intensity that pervades the respective regions of different transparency 11, 12 of the decorative layer 1. Here, it is advantageous for the mask to be dynamically adapted to the increased inhomogeneous structure. Such a dynamic adaptation can also be implemented by a camera-based printing system, as will be described below.

The image can also be introduced in the masking layer 3, above all when this is a multilayer masking layer, which is to be imaged by the backlighting in the display region 2. Furthermore, the interior component generally comprises a carrier structure, on which the decorative layer 1 is arranged and which can have the support means for the light source 4. To protect the visible surface of the decorative layer 1, this can be sealed on the observer side with a transparent layer, preferably a colourless transparent layer, in particular a clear varnish coat.

The possibilities for applying the masking layer 3 to the decorative layer 1 extend from the printing procedure, for example by halftone printing to lamination with corresponding films.

A method for the production of an interior component having at least one inhomogeneous structure decorative layer 1 here primarily relates to the masking of the regions 11, 12 with different transparencies of the decorative layer 1. Thus, at least the region 2 of the decorative layer 1 is in particular to be masked, which is provided to display an image by means of a light source, which illuminates the decorative layer and is arranged on the side of the decorative layer 1 that is facing away from the observer. For the masking, the masking layer 3 is arranged accordingly at least in the region 2 of the image display on the light source side of the decorative layer 1, such that the masking sections with lower transparency 31 are arranged on the decorative layer regions with higher transparency 11 and the masking sections with higher transparency 32 are arranged on the decorative layer regions with lower transparency 12.

The problems arising hereby with respect to the positional exactitude of the masking sections on the corresponding regions make it necessary to have a flexible adaptation of the masking layer due to the variable, potentially increased structures.

To that end, a shading of the regions of higher transparency 11 can be achieved by means of masking sections 31 of lower transparency being applied to the structure in an adapted manner, or can be applied to the structure in an adapted manner through the exposed photosensitive layer shown in FIGS. 4 and 5.

The production of a masking layer 3 with adapted masking sections 31, 32 to be applied to the decorative layer 1 can comprise the steps of illuminating the regions 11, 12 of the decorative layer 1 at least in the region 2 of the image display and the photographic imaging of the illuminated regions 11, 12, such that the masking layer 3 with the masking sections 31, 32 can be formed virtually from a negative of the photographic image of the illuminated regions 11, 12. Here, a further suitable printing procedure can be used, which prints the negative of the photographic image either directly onto the decorative layer or onto a film which is then applied to the decorative layer.

The adaptation of the masking layer 3 to the structure of the decorative layer 1 is possible through the exposure of the photosensitive layer, which is applied to the light source side of the decorative layer 1 at least in the region 2 of the image display. The photosensitive layer can also be applied to a carrier structure, which is arranged underneath the decorative layer, such that the photosensitive layer is arranged on the light source side of the decorative layer. The exposure thus takes place from the observer side through the decorative layer 1, such that the light intensities transmitted through the decorative layer 1 depending on the transparency of the respective regions, which light intensities strike the photosensitive layer, induce a corresponding photoreaction, i.e. reduction in transparency, on the respective sections. Thus, the masking sections with different transparencies can be formed directly in an advantageous manner, while the chromogenic materials of the photosensitive layer photoreact through the exposure, which can lead to an increase in absorbance according to the absorbed light intensity, such that the sections of the photosensitive layer that are exposed more strongly through the regions of higher transparency of the decorative layer form the masking sections of lower transparency and vice versa. Alternatively to such a photochromically configured masking layer, the photosensitive layer can be developable material that is treated with a developer after exposure so as to dye the correspondingly exposed regions. Here, the photosensitive layer can be applied as a varnish to the decorative layer or to the carrier structure arranged thereunder, wherein, here, the photosensitive varnish is also exposed through the decorative layer and thus developed.

Both the photographic imaging method and the direct exposure method for forming the masking layer allow brightness gradations adapted to the decorative structure, even with smooth transitions.

Various exposure angles can be used in the exposure method, in order to obtain a consistent image or to diminish the formation of edges. Alternatively or additionally, the exposure light source can be guided dynamically above the decorative layer. The use of an exposure light source, which generates coherent light, can reduce scattering and enable the implementation of extensive printing regions.

Further optional method steps relate to a repeated application of layers to create a multilayer masking layer. This can be used to gradate the transparency at transitions between different regions, in particular in increased structures; however, 3D effects can also be obtained with a multilayer masking layer, above all when the image in the display region is integrated into the masking layer.

If an exposure method is used to produce the masking sections of the masking layer, the image that is to be integrated into the masking layer is exposed as well during the exposure step, such that a further method step is dispensed with.

The interior component according to the invention, which can be produced by means of a method according to the invention, provides a reduction in the light-dark contrast in the illumination of structured decorations, in particular also in inhomogeneous and increased decorative structures. Simultaneously large masking regions can be structured by the exposure method and images such as symbols can, if necessary, simultaneously be introduced into the masks. From this, low inhomogeneity of symbol displays results in the illumination of inhomogeneous decorations.

1.-12. (canceled)

13. A motor vehicle interior component with a multilayer design, which comprises
at least one inhomogeneously structured decorative layer (1), which has a plurality of regions (11, 12) of different transparencies, wherein the decorative layer (1) is an interior component surface that is facing towards an observer and comprises at least one region (2) for the display of an image, and
a light source (4) provided at least in the region (2) of the image display on the side of the decorative layer (1) that is facing away from the observer,
wherein the decorative layer (1) has a masking layer (3) on the side of the light source at least in the region (2) of the image display, which consists of masking sections (31, 32) of different transparencies, wherein masking sections of lower transparency (31) lie on regions of higher transparency (11) of the decorative layer (1) and masking sections of higher transparency (32) lie on regions of lower transparency (12) of the decorative layer (1), and
wherein the interior component comprises a carrier structure on which the decorative layer (1) is arranged, and/or a transparent layer, preferably a colourless transparent layer, in particular a clear varnish coat, is applied to the decorative layer (1) on the observer side.

14. The interior component according to claim 13, wherein the respective transparency of the masking sections (31, 32) is selected in such a way that the total transparency of a region of higher transparency (11) of the decorative layer (1) and of the masking section of lower transparency (31) lying thereon is the same as a total transparency of a region of lower transparency (12) of the decorative layer (1) and of the masking region of higher transparency (32) lying thereon.

15. The interior component according to claim 13, wherein the masking layer (3) comprises at least one imprinted coating, a varnish coating, a film layer or paper layer or a combination of the aforementioned layers.

16. The interior component according to claim 13, wherein the masking layer (3) comprises a photosensitive layer exposed from the observer side through the decorative layer (1), wherein the different transparencies of the masking sections (31, 32) are formed respectively by an exposure intensity that pervades the respective regions of different transparency (11, 12) of the decorative layer (1).

17. The interior component according to claim 13, wherein the masking layer (3) comprises the image display.

18. The interior component according to claim 13, wherein the decorative layer (1) is a wooden decorative layer (1), wherein the regions (11, 12) of different transparencies are formed by the wood grain, and a surface area of the regions (11, 12) of different transparencies is variable from the light source side to the observer side.

19. A method for the production of an interior component with at least one inhomogeneous structure decorative layer (1), which has a plurality of regions (11, 12) of different transparencies and comprises at least one region (2) for the display of an image, wherein a light source (4) is arranged at least in the region (2) of the image display on the side of the decorative layer (1) facing away from the observer,
comprising the following steps:
illuminating the regions (11, 12) of the decorative layer (1) at least in the region (2) of the image display before the arrangement of the masking layer (3),
photographically imaging the illuminated regions (11, 12),
producing the masking layer (3) with the masking sections (31, 32) according to the photographic image of the illuminated regions (11, 12), and
applying the masking layer (3) at least to the region (2) of the image display of the light source side of the decorative layer (1), wherein masking layers of lower transparency (31) are applied to regions of higher transparency (11) of the decorative layer (1) and masking sections of higher transparency (32) are applied to regions of lower transparency (12) of the decorative layer (1).

20. The method according to claim 19, wherein the application of the masking layer (3) comprises the following steps:
applying a photosensitive layer at least to the region (2) of the image display of the light source of the decorative layer (1),
exposing the photosensitive layer from the observer side through the decorative layer, then forming masking sections (31, 32) of different transparencies according to the light intensities transmitted through the regions (11, 12) of the decorative layer (1).

21. The method according to claim 20, comprising at least one of the following steps:
using various exposure angles during exposure and/or dynamically guiding an exposure light source above the decorative layer (1), and
using an exposure light source that generates coherent light.

22. The method according to claim 19, comprising at least one of the following steps:
repeated application of layers and the formation of a multilayer masking layer (3),
generation of the image display in the masking layer (3),
arrangement of the masked decorative layer (1) on a carrier structure of the interior component, and
formation of a transparent layer on the observer side of the decorative layer (1), wherein the transparent layer is preferably a colourless transparent layer, in particular a clear varnish coat.
